(19) United States
(12) Patent Application Publication
(10) Pub. No.: US 2026/0296226 A1
(43) Pub. Date: Oct. 1, 2026

(54) CHARGING DEVICE AND CHARGING METHOD FOR AN ELECTRICAL ENERGY STORE

(71) Applicant: Robert Bosch GmbH, Stuttgart (DE)

(72) Inventors: Seifeldin Tarek Mohamed Shaaban, Stuttgart (DE); Tahir Harman, Tamm (DE)

(21) Appl. No.: 19/479,537

(22) PCT Filed: Apr. 23, 2024
(86) PCT No.: PCT/EP2024/061064

§ 371 Date: Oct. 28, 2025

(30) Foreign Application Priority Data
May 11, 2023 (DE) 10 2023 204 373.4

(51) Int. Cl. B60L 53/10; B60L 53/16; B60L 53/20; B60L 53/62; B60L 53/66

(52) U.S. Cl. CPC B60L 53/11; B60L 53/16; B60L 53/20; B60L 53/62; B60L 53/66

(57) ABSTRACT

The invention discloses a concept for charging an electrical energy store, for example a traction battery in an electric vehicle. For this purpose, superimposing an AC voltage at a predetermined amplitude and frequency on a DC voltage which is intended for charging the electrical energy store is proposed. The AC voltage can be adjusted according to the properties of the electrical energy store to be charged with respect to the impedance of the electrical energy store.

### BACKGROUND

The present invention relates to a charging device for an electrical energy store, in particular for an electrical energy store in an electric vehicle. The present invention further relates to a charging method for such an energy store.

Fully or at least semi-electrically powered vehicles have a so-called traction battery. This traction battery serves as an electrical energy store and provides the electrical energy required in order to propel the vehicle.

For example, a single-phase or multi-phase electrical AC voltage can be used in order to charge the traction battery. The AC voltage is generally rectified by means of a charging circuit provided in the vehicle and adjusted to a voltage level that is suitable for charging the traction battery. Alternatively, it is also possible to provide an electrical DC voltage at the vehicle and to use this in order to charge the traction battery. Higher charging powers are generally available for charging the traction battery via DC voltage. In addition to the current state of charge or a possible limitation for a maximum charging current, the temperature of the battery cells of the traction battery during the charging process with DC current also represents a limiting quantity.

For example, publication DE 10 2014 203 859 A1 describes a method for temperature control of a traction battery arranged in a vehicle during a charging process at a charging station in order to bring the battery cells to a temperature that is as suitable as possible for the charging process.

### SUMMARY

The present invention discloses a charging device and a charging method for an electrical energy store having the features of the disclosure.

The following is provided, accordingly:

A charging device for an electrical energy store, having an input port, an output port, and a superimposition means. The input port is configured so as to be connected to a DC power source. The output port is configured so as to be connected to the electrical energy store. The superimposition means is configured so as to superimpose a predetermined AC voltage on an electrical DC voltage supplied at the input port. Furthermore, the superimposition means is configured so as to provide the DC voltage superimposed with the AC voltage at the output port. The predetermined AC voltage with which the DC voltage is superimposed has a specified frequency and a specified amplitude.

The following is furthermore provided:

A charging method for an electrical energy store, having a step for providing an electrical DC voltage. Furthermore, the method comprises a step of superimposing the supplied electrical DC voltage with a predetermined AC voltage. The predetermined AC voltage has a specified frequency and a specified amplitude. Furthermore, the method comprises a step of providing the electrical DC voltage with the superimposed AC voltage at the electrical energy store.

The present invention is based on the finding that electrical energy stores, for example the traction battery of an electric vehicle, can have an internal electrical resistance, whose real part of the impedance depends on a frequency of the charging current. For example, the real part of the impedance for the internal resistance of a traction battery can have a maximum at approximately 0.1 Hz and can initially decrease with a subsequent increase in frequency. Furthermore, for example, in the range of approximately 1 kHz, a minimum of the real part of the impedance can result, while with still increasing frequencies, the real part of the impedance increases again.

The present invention is further based on the finding that a maximum permissible charging power or a maximum permissible charging current of a traction battery can depend on numerous parameters, for example the cell temperature of the battery cells. In particular, the charging power can be limited at relatively low temperatures.

Starting from these findings, it is an idea of the present invention to provide a concept for charging an electrical energy store, in particular the traction battery of an electric vehicle, which allows for improved charging performance of the traction battery. According to the present invention, it is provided for this purpose that no pure electrical DC voltage is provided for charging the traction battery, but rather that the DC voltage for charging the battery is superimposed with an AC voltage fraction. Due to such a charging voltage with a superimposed AC voltage fraction, the impedance of the traction battery varies. In particular, the real part of the impedance drops to a frequency of approximately 1 kHz, for example. Higher charging currents receivable by the traction battery can thereby be achieved.

In addition, the battery cells heat up due to the superimposed AC voltage fraction. This can cause a further decrease in the internal cell resistance, especially at cold temperatures. Accordingly, the battery cells very quickly reach a cell temperature which allows for higher charging currents. Thus, the charging process for the traction battery can be accelerated by the concept according to the invention, whereby a desired state of charge is achieved more quickly or a greater amount of energy can be transferred into the traction battery within a specified period of time.

According to one embodiment, the superimposition means is configured so as to adjust the frequency of the AC voltage superimposed on the DC voltage in a range between about 100 Hz and 1000 Hz. Depending on the application, limits for the frequency of the AC voltage that deviate from the latter are also possible. If necessary, the frequency can also be adjusted in an interval between 10 Hz and 2,000 Hz or other suitable limits. The frequency can be selected to come as close as possible to the minimum of a real part of the impedance of the battery cells in the traction battery. It has been shown that the superimposition of the DC voltage with an AC voltage in the mentioned range does not lead to a significant degradation of the traction battery's state of health (SoH). In addition, AC voltage components in the specified range are also not affected, or only affected to a very small extent, by any bus link capacitors present. In particular, it is possible for the superimposition means to select and adjust the frequency of the AC voltage as a function of the battery impedance, the aging behavior of the battery, the on-board power system properties (including the properties of the bus link capacitor) and, if applicable, also the properties of the AC voltage generation.

According to one embodiment, the superimposition means is configured so as to adjust the frequency of the AC voltage and/or the amplitude of the AC voltage using a battery voltage, a state of charge, a cell temperature, and/or an impedance of the electrical energy store connected at the output port of the charging device. In this way, the charging voltage or the charging current for charging the electrical energy store can be adapted specifically to the respective properties of the electrical energy store to be charged. In particular, it is possible, for example, to influence the temperature development in the battery cells through the AC voltage components superimposed on the DC voltage and thus to condition the battery cells as quickly as possible to an optimal temperature for charging.

According to one embodiment, the amplitude of the AC voltage superimposed on the DC voltage is less than or equal to the DC voltage fraction of the electrical voltage supplied at the output port. Thus, even with a DC voltage superimposed with an AC voltage, there is always an electrical voltage with the same sign, so that the electrical voltage never falls below 0 Volts.

According to one embodiment of the charging device, the input port of the charging device is configured so as to be coupled to a DC voltage charging station for an electric vehicle. The input port of the charging device thus has an electrical DC voltage with at least an approximately constant voltage level. This DC voltage can then be superimposed with an electrical AC voltage by means of the superimposition means, and thus the combination of the DC voltage with the superimposed AC voltage is provided for charging the traction battery in the electric vehicle.

According to one embodiment, the superimposition means is configured so as to adapt a voltage level of the DC voltage applied at the input port of the charging device and to superimpose the AC voltage on the adapted DC voltage. In this way, the DC voltage for recharging the traction battery in the voltage level can be adapted to the specific requirements of the traction battery to be charged. For this purpose, a corresponding DC voltage conversion can be carried out, for example in the superimposition means. Thus, for example, an electrical energy store having a higher voltage level of, for example, 800 to 1000 Volts can also be charged by a DC voltage charging station, which is only configured for lower voltage levels of, for example, 400 V.

According to one embodiment, the superimposition means comprises an electrical power converter and an electrical machine. A first connection point of the DC voltage port of the electrical power converter is electrically coupled to a first connection point of the output port of the charging device. A second connection point of the DC voltage port is electrically coupled to a second connection point of the output port of the charging device. Furthermore, each phase port of the electrical machine is electrically coupled to a corresponding phase port of the power converter. A first connection point of the input port of the charging device is electrically coupled to a star point of the electrical machine. Finally, a second connection point of the input port of the charging device is electrically coupled to the second connection point of the output port of the charging device. In this way, the components, in particular the power converter and the electrical machine of an electrical drive system already present in an electric vehicle, can be used in order to superimpose an AC voltage on the DC voltage and, if applicable, to adapt the voltage level of the DC voltage. Thus, the adjustment of the charging voltage for the charging concept according to the invention can be implemented in a particularly simple manner.

According to one embodiment, the charging device is integrated into a DC voltage charging station for an electric vehicle. In particular, this can be a rapid charging station for electric vehicles that provides a DC voltage for charging the traction battery in an electric vehicle. The output port of the charging device is configured so as to be coupled to a DC voltage charging port for an electric vehicle. In such a configuration, the DC voltage superimposed with an AC voltage can thus be generated and provided entirely already in the charging station. If necessary, a wireless or wired communication link between the vehicle and the charging station can be provided. Data can be exchanged via such a communication link in order to specify the frequency and/or amplitude of the AC voltage to be superimposed on the DC voltage.

According to one embodiment, the input port of the charging device is configured so as to be coupled to a first electrical energy store and the output port of the charging device is configured so as to be coupled to a second electrical energy store. For example, the first electrical energy store and the second electrical energy store can also each be a part of a traction battery for an electric vehicle. In such a configuration, the charging device can be configured so as to transfer electrical energy from the input port and thus from the first electrical energy store to the output port and thus the second electrical energy store. In this way, for example, a reverse-charging of electrical energy from the first electrical energy store to the second electrical energy store is possible. By superimposing the DC voltage supplied by the first electrical energy store with an AC voltage, it is also possible to thermally condition the battery cells of the electrical energy store, for example, and thus prepare them for an impending charging operation.

The above embodiments and further developments can be combined with one another in any desired manner insofar as advantageous. Additional embodiments, further developments, and implementations of the invention also include inventive feature combinations not described or explicitly specified hereinabove or hereinafter with respect to exemplary embodiments. The person skilled in the art will in particular also add individual aspects as improvements or additions to the respective basic forms of the invention.

### BRIEF DESCRIPTION OF THE DRAWINGS

Further features and advantages of the invention are explained hereinafter with reference to the drawings. Shown are:

FIG. 1: a schematic illustration of a block diagram of a charging device according to one exemplary embodiment;

FIG. 2: a schematic illustration of a current-time diagram illustrating the charging voltage of a charging device according to one embodiment;

FIG. 3: a schematic illustration of a block diagram of a charging device for charging an electrical energy store according to one embodiment;

FIG. 4: a schematic illustration of a possible circuit concept for a charging device according to one embodiment;

FIG. 5: a schematic diagram of an assembly for charging an electrical energy store with a charging device according to a further embodiment;

FIG. 6: a schematic diagram of an assembly for charging an electrical energy store with a charging device according to yet another embodiment; and

FIG. 7: a flow chart that forms the basis for a charging method according to one embodiment.

### DETAILED DESCRIPTION

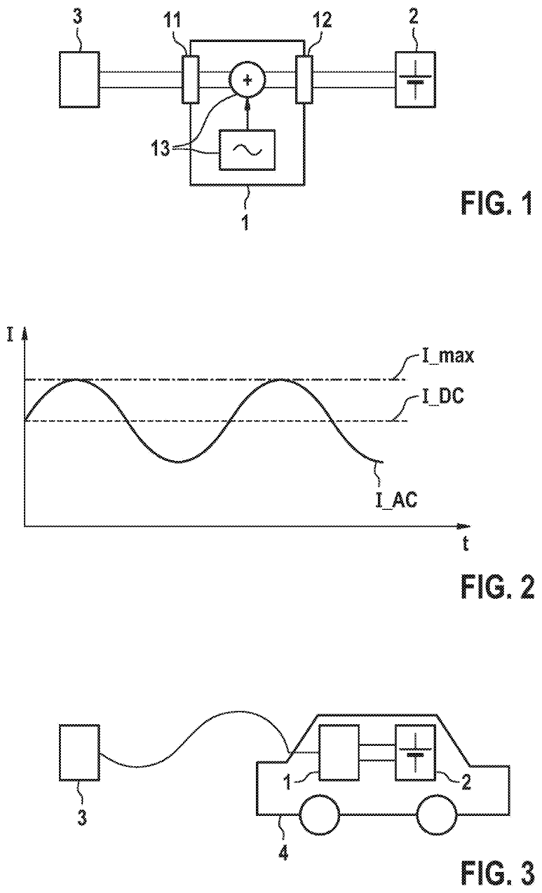

FIG. 1 shows a schematic view of a block diagram to illustrate an assembly for charging an electrical energy store 2 according to one embodiment. For example, the electrical energy store 2 can be the traction battery of a vehicle that is fully or at least partially electrically driven. To charge the electrical energy store 2, electrical energy in the form of a DC voltage can be supplied from a DC voltage source 3. Such a charging of the electrical energy store 2 by means of DC voltage is used in particular in rapid charging processes. Currently, charging powers of well over 100 kW, in particular more than 200 kW or even more than 250 kW, are possible. Limiting factors for the maximum charging power for charging an electrical energy store 2 are, in addition to the maximum electrical power that can be retrieved from the DC voltage source 3, parameters of the electrical energy store 2. For example, the maximum charging power can be limited by the temperature of the battery cells, the impedance of the electrical energy store 2, the current state of charge, or possibly other parameters. In particular, it is not possible, for example, to charge the electrical energy store 2 with the maximum possible charging power as long as the battery cells of the electrical energy store 2 have a too low temperature.

The current parameters of the electrical energy store 2 can be sensed, for example, by means of a battery management system (not shown). The maximum charging power can then be adjusted in the form of a maximum permitted charging current and/or a charging voltage. For example, the corresponding data or specifications can be transmitted to the DC voltage source 3.

A charging device 1 is further provided for charging the electrical energy store 2 according to the concept shown in FIG. 1. This charging device 1 comprises an input port 11, an output port 12, and a superimposition means 13. The input port 11 can be electrically coupled to the DC voltage source 3. The DC voltage source 3 can thereby provide the electrical energy provided for charging the electrical energy store 2 in the form of a suitable DC voltage at the input port 11. The output port 12 can be electrically coupled to the electrical energy store 2. Thus, the electrical voltage applied at the output port 12 can be supplied at the electrical energy store 2 and can thereby charge the electrical energy store 2.

Furthermore, a superimposition means 13 is provided in the charging device 1. This superimposition means 13 can superimpose an AC voltage on the DC electrical voltage supplied at the input port 11. The energy required for the electrical AC voltage to be superimposed can be taken from the DC voltage applied at the input port 11. In other words, the superimposition means 11 does not provide any additional energy for charging the electrical energy store 2.

The superimposition means 13 can thus superimpose an AC voltage with a specified frequency and a specified amplitude on the DC electrical voltage supplied at the input port 11. The amplitude of the superimposed AC voltage is less than or at most equal to the value of the DC voltage. Thus, it is ensured that the DC voltage superimposed with the AC voltage always has a positive value and never becomes negative. The amplitude and frequency of the superimposed AC voltage can be adjusted according to the properties of the electrical energy store 2 connected at the output port 12. In particular, the frequency of the superimposed AC voltage can be adapted based on the properties of the electrical energy store 2, for example. For example, the impedance of the electrical energy store 2 can be considered for the particular frequency of the AC voltage. The frequency can be adjusted so that a real part of the impedance of the electrical energy store 2 becomes as low as possible, preferably minimally. For this purpose, the frequency can be adjusted in a range between 100 Hz and 1000 Hz, for example. Depending on the application, limits for the frequency of the AC voltage that deviate from the latter are also possible. If necessary, the frequency can also be adjusted in a range between 10 Hz and 2,000 Hz or other suitable limits.

For example, the correlations between amplitude and frequency of the AC voltage to be superimposed and the respective properties of the electrical energy store 2 can be provided in the form of a previously calculated table (lookup table) or similar. Alternatively, suitable formula-based relationships are also possible. For example, the respective data as a basis for setting amplitude and frequency can be acquired and provided by means of a suitable battery management system or similar.

By appropriately adjusting the amplitude and/or frequency of the superimposed AC voltage, it is thus possible to superimpose an AC voltage on the DC voltage for charging the electrical energy store 2, and thereby minimize the real part of the impedance of the electrical energy store 2 through the voltage ripple of the superimposed AC voltage. Furthermore, by suitably parameterizing the amplitude or frequency of the AC voltage, the heat generation in the electrical energy store 2 can also be influenced. This makes it possible, for example, to influence the temperature behavior of battery cells below an optimal charging temperature by the selected superimposition of the AC voltage, so that the battery cells heat up as quickly as possible. After the battery cells have reached a suitable temperature, the electrical energy store 2 can then be charged at a higher, possibly maximum, charging power. Thus, the charging of the electrical energy store 2 to a desired state of charge (SoC) can be achieved within a shorter period of time. Alternatively, a greater amount of electrical energy can be charged into the electrical energy store 2 within a specified period of time.

FIG. 2 shows a current-time plot of the curve of an electrical charging current in a charging device 1 according to one embodiment. The dashed line I_DC represents the DC voltage fraction of the charging current. As already described, an AC fraction I_AC is superimposed on this charging current. Care must be taken to ensure that on the one hand, the DC current I_DC which is superimposed with the AC current fraction I_AC does not exceed the maximum permitted charging current I_max. On the other hand, the sum of the DC component I_DC and the AC component I_AC should always be positive and not negative.

FIG. 3 shows a schematic view of a concept for charging an electrical energy store 2 with a charging device 1 according to one embodiment. In the embodiment shown here, the electrical DC voltage for charging the electrical energy store 2 is provided by an external DC voltage source 3, for example a DC voltage charging station. The charging device 1 as well as the electrical energy store 2 are both arranged within an electric vehicle 4. The DC voltage charging station can be electrically coupled to the vehicle 4 and thus to the input port 11 via a DC voltage charging port. The DC voltage charging station provides an at least approximately constant electrical DC voltage. This is superimposed with an AC voltage fraction by means of the charging device 1. The combination of the electrical DC voltage and the superimposed AC voltage is then provided as the charging voltage to the electrical energy store 2.

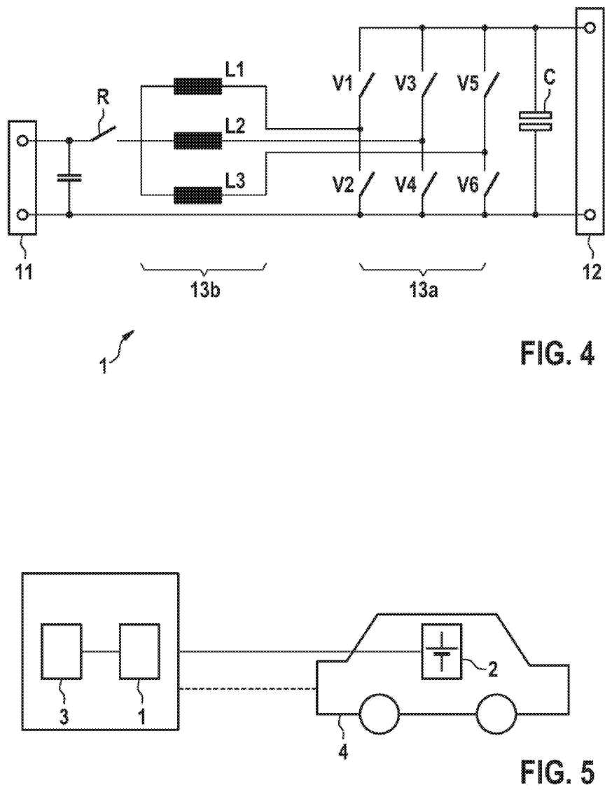

FIG. 4 shows a schematic illustration of a basic circuit concept of a superimposition means 13 according to one embodiment. In the embodiment illustrated herein, the superimposition means 13 can be realized, for example, from an electrical power converter 13a and an electrical machine 13b.

This can in particular also represent the components of the electrical drive system of an electric vehicle. Thus, by utilizing the already existing components of the electrical drive system, no additional hardware components, or at least approximately no additional hardware components, are required.

The electrical power converter 13a can be electrically connected to the terminals of the output port 12 at a DC voltage port. The AC voltage ports of the power converter 13a can be electrically connected to corresponding phase ports of the electrical phases L1, L2, and L3 of the electrical machine 13b. A star point of the electrical machine 13b can be electrically connected to a first connection point of the input port 11 via a relay R. A second connection point of the input port 11 is electrically connected to a connection point of the DC voltage port of the power converter 13a and thus to the corresponding connection point of the output port 12. Furthermore, a bus link capacitor C can be provided at the DC voltage port.

By suitably actuating the switching elements V1 to V6 of the power converter 13a, it is thus possible on the one hand to superimpose an AC voltage on the electrical DC voltage supplied at the input port 11. In addition, taking advantage of the motor inductances L1 to L3, the voltage level of the electrical DC voltage at the input port 11 can also be adapted in order to adapt the voltage to a voltage level that is suitable for charging the electrical energy store 2. In particular, in addition to the superimposition of the charging voltage with an AC voltage fraction, the voltage level of the electrical DC voltage provided at the input side can also be increased by means of a suitable booster operation in order to charge an electrical energy store 2 with a higher voltage level.

FIG. 5 shows a schematic illustration of a basic diagram of a concept for charging an electrical energy store 2 with a charging device 1 according to a further embodiment. The embodiment according to FIG. 5 differs from the embodiment described in connection with FIG. 3 in particular in that the superimposition means 1 is provided outside the vehicle 4, for example in the DC voltage charging station with the DC voltage source 2. Thus, the superimposition of the DC voltage with the desired AC voltage can also be carried out by the power electronics within the DC voltage charging station. In this case, for example, a wired or wireless communication between the vehicle 4 and the charging station can be carried out in order to specify the necessary parameters for adjusting the amplitude and/or frequency of the AC voltage to be superimposed.

FIG. 6 shows a schematic illustration of a circuit concept for charging and reverse-charging an electrical energy store according to a further embodiment. In the embodiment shown in FIG. 6, the input port 11 is electrically coupled to a first electrical energy store 2a. The output port 12 of the charging device 1 is electrically coupled to a second electrical energy store 2b. This allows, for example, electrical energy to be taken from the first electrical energy store 2a and transferred into the second energy store 2b. Here too, the DC voltage supplied by the first electrical energy store 2a can be superimposed with an AC voltage. During such a charge reversal process, it is possible on the one hand to transfer electrical energy from the first electrical energy store 2a into the second energy store 2b. In particular, by superimposing the DC voltage with an AC voltage fraction, the second electrical energy store 2b to be charged can also be thermally conditioned. Thus, already while driving to a DC voltage charging station, the electrical energy store 2b can be brought to a suitable temperature in order to be able to carry out the charging process with the highest possible charging power. Of course, by means of a suitable circuit concept, electrical energy from the second electrical energy store 2b can also alternatively be reverse-charged into the first electrical energy store 2a. In this way, both of the electrical energy stores 2a and 2b can be thermally conditioned.

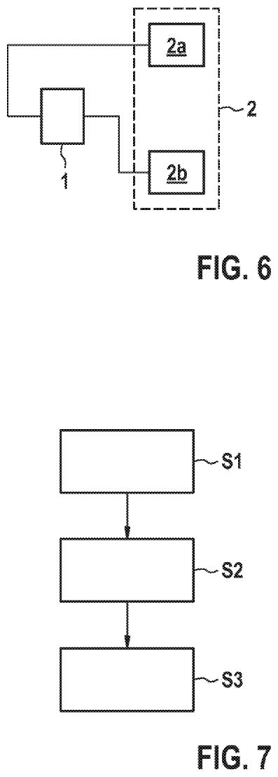

Finally, FIG. 7 shows a flow diagram underlying a charging method for an electrical energy store 2 according to one embodiment. In principle, the method can comprise any desired steps that have already been described above in connection with the charging device 1. Analogously, the concepts described above for the charging devices 1 can also comprise any components that may be required in order to implement the method described below.

In a step S1, first an electrical DC voltage is provided. In step S2, this electrical DC voltage can then be superimposed with a predetermined AC voltage. This predetermined AC voltage can have a specified frequency as well as a specified amplitude. Finally, in step S3, the electrical DC voltage with the superimposed electrical AC voltage is supplied at the electrical energy store 2 to be charged.

In summary, the present invention relates to a concept for charging an electrical energy store, for example a traction battery in an electric vehicle. For this purpose, superimposing an AC voltage at a predetermined amplitude and frequency on a DC voltage which is intended for charging the electrical energy store is proposed. The alternating voltage can be adjusted according to the properties of the electrical energy store to be charged with respect to the impedance of the electrical energy store.

1. A charging device (1) for an electrical energy store (2), the charging device (1) comprising:
an input port (11) configured to be connected to a DC voltage source (3);
an output port (12) configured to be connected to the electrical energy store (2); and
a superimposition means (13) configured to superimpose a predetermined AC voltage on a DC voltage supplied at the input port (11) and to provide the DC voltage that has been superimposed with the AC voltage on the output port (12),
wherein the predetermined AC voltage has a specified frequency and a specified amplitude.

2. The charging device (1) according to claim 1, wherein the superimposition means (13) is configured to adjust the frequency of the AC voltage within an interval between 100 and 1000 Hz.

3. The charging device (1) according to claim 1, wherein the superimposition means (13) is configured to adjust the frequency and/or the amplitude of the AC voltage using a battery voltage, a state of charge, a cell temperature, and/or an impedance of the electrical energy store (2) connected at the output port (12) of the charging device (1).

4. The charging device (1) according to claim 1, wherein the amplitude of the AC voltage is less than a DC voltage fraction of the electrical voltage supplied at the output port.

5. The charging device (1) according to claim 1, wherein the input port (11) of the charging device (1) is configured to be coupled to a DC voltage charging station for an electric vehicle.

6. The charging device (1) according to claim 1, wherein the superimposition means (13) is configured to adapt a voltage level of the DC voltage supplied at the input port and to superimpose the AC voltage on the adapted DC voltage.

7. The charging device (1) according to claim 1, wherein the superimposition means (13) comprises an electrical power converter (13 a) and an electrical machine (13b),
wherein a first connection point of a DC voltage port of the electrical power converter (13a) is electrically coupled to a first connection point of the output port (12) of the charging device (1), and a second connection point of the DC voltage port is electrically coupled to a second connection point of the output port (12) of the charging device (1),
wherein a respective phase port of the electrical machine (13b) is electrically coupled to a corresponding phase port of the power converter (13a), and
wherein a first connection point of the input port (11) of the charging device (1) is electrically coupled to a star point of the electrical machine (13b), and a second connection point of the input port (11) of the charging device (1) is electrically coupled to the second connection point of the output port (12) of the charging device (1).

8. The charging device (1) according to claim 1, wherein the input port (11) of the charging device (1) is configured to be coupled to a first electrical energy store (2a), and
the output port (12) of the charging device (1) is configured to be coupled to a second electrical energy store (2b), and
wherein the charging device (1) is configured to transfer electrical energy from the input port (11) to the output port (12).

9. The charging device (1) according to claim 1, wherein the charging device (1) is integrated in a DC voltage charging station for an electric vehicle, and
the output port (12) of the charging device (1) is configured to be coupled to a DC voltage charging port for an electric vehicle.

10. A charging method for an electrical energy store (2), the method comprising:
providing (S1) an electrical DC voltage;
superimposing (S2) a predetermined AC voltage on a supplied electrical DC voltage, wherein the predetermined AC voltage has a specified frequency and an specified amplitude; and
providing (S3) the electrical DC voltage with the superimposed AC voltage at the electrical energy store (2).
